(19) United States
(12) Patent Application Publication
(10) Pub. No.: US 2012/0310750 A1
(43) Pub. Date: Dec. 6, 2012

(54) INTERFACE AND MODULE FOR REAL-TIME ADVERTISING PRESENTATION

(75) Inventors: Jason Schutzbank, Havertown, PA (US); Jeffrey Troncone, Long Island City, NY (US)

(73) Assignee: Intercast Networks, Inc., McMurray, PA (US)

(21) Appl. No.: 13/486,380

(22) Filed: Jun. 1, 2012

Related U.S. Application Data
(60) Provisional application No. 61/492,155, filed on Jun. 1, 2011.

(51) Int. Cl. G06Q 30/02

(52) U.S. Cl. 705/14.72; 705/14.73

(57) ABSTRACT

An expanded function set for advertising campaigns and social network driven sales environments, unified across presenting sites and maintained at the presenting site. A banner ad can include a live streaming product presentation, such as an infomercial where users can expand the presentation, purchase the product, and share with networked friends. Video on demand and pay per view/download content can be provided via the integrated system and user experience.

### CROSS-REFERENCE TO RELATED APPLICATIONS

The present application claims the benefit under 35 U.S.C. §119(e) of U.S. Provisional Patent Application Ser. No. 61/492,155 filed on Jun. 1, 2011, the content of which is hereby incorporated by reference.

### FIELD OF THE DISCLOSURE

The invention relates generally to systems and methods for reaching and engaging persons on the internet, and more specifically, relates to exemplary embodiments of systems and methods for engaging person on the internet in commerce, social networking, surveys and in the viewing of live and produced media for purposes of advertising, brand awareness, entertainment, and information dissemination as it relates to products, consumer brands and public individuals and/or groups.

### BACKGROUND OF THE DISCLOSURE

The use of Internet based systems to sell goods and services, provide information, promote social interaction, gauge interest and provide data on those interactions are well known, and individually, is the domain of many companies currently operating on the Internet, all with a traditional web address. Despite their popular use, these websites offer limited functionality with limited, or non-existent, user engagement. Those wishing to participate in certain online activities must do so on a designated site that the user must specifically go to, and with little or no integration of the activities.

Many internet-based advertising formats and platforms are designed to “pull” the consumer away from where the initial interaction took place to a platform dedicated to the advertised subject (e.g., a car ad is typically designed to pull a viewer from the primary site they see the ad on to the car manufacturing or sales site). As such, advertising components designed to promote the service and/or activity of advertising companies typically appear on websites other then those of the principle company and function as links to other websites (e.g., a sales landing page for one or more products of one or more advertising companies).

Conventional companies serving the banner ad and rich media needs of their clients typically do so with ads that offer singular functionality (e.g., a singular or limited “rich media” functionality, along with standard ad functions). Although each of these companies offers a wide variety of rich media features within their ad units, the ad units only feature a single feature per campaign or very limited set of features per campaign.

Limited integration of site functions does exist in conventional applications. Some social networking sites have widgets or application modules that allow other sites to interact with the social networking site. For example, a publisher may put a “like” widget in their articles, which may allow social network users to indicate to other social network users, and/or users-at-large how popular a particular article is among the general population and/or among a user's social network. Widgets may allow users to share content (e.g., a video or a product) in their social network “feed,” but generally do not provide any real-time “shared experience” functions beyond sharing/recommending.

Additionally, when creating an advertisement, or an Internet experience, advertisers are limited in the functionality available; creating a singular point of interest for the target of the ads (e.g., a video file, and audio file, or a simple interaction point). It can be very difficult for an advertiser to create a unique experience with multiple interactive components.

Furthermore, many activities and interactions are time-based (e.g., concerts, lectures, live broadcasts). If a user activates one of these time-based interactions later than the start time, the user will have missed not only the broadcasted content, but also any associated content such as chats or feedback from a particular time period.

Thus, it may be beneficial to provide a unique interactive experience, in a portion of a webpage, without requiring the interacting user to leave the current webpage. It may be further beneficial for the interacting user to have the ability to view an event from the start or at an earlier time period, even if the user has started the content late, while also allowing the interacting user to view the associated content at the earlier time period. It may be further beneficial to create a system that allows an advertiser to easily select individual modules for use in an advertisement or content banner, to allow for more features in the experience.

### SUMMARY OF THE DISCLOSURE

Exemplary embodiments of the present disclosure provide a comprehensive platform from which users can engage in all or some of the interactions available through traditional means from anywhere on the web. The exemplary embodiments can enable agents to deploy the embodiments on any website and provide users with full functionality without leaving the site those embodiments were “published” on. Exemplary embodiments can also simultaneously globally transmit dozens of unique client campaigns to thousands of host web sites around the world, viewable by millions of people on computers (e.g., PC's, mobile phones, portable Wi-Fi enabled media devices, etc.). The same campaign can be deployed on different platforms and with varying functionality, all in sync with one-another.

Exemplary embodiments of the present disclosure can include an advertising component and trigger (e.g., a banner ad), which can be an integrated module that, when initiated (e.g., by, a mouse over), launches an interface, which can then appear over the web page where the ad was published. Exemplary embodiments of the present interfaces can offer clients and publishers added visibility and additional branding opportunities. Exemplary embodiments can provide an advertiser brand, the advertising company that has created the ad, along with the brand being advertised. Therefore, if an ad is unique, compelling, and/or interesting, the ad presenter's brand can also benefit from a recognizable element in the campaign. This way, visitors that engage with an exemplary viewer on one site might be more likely to engage with it on another site because they will have an expectation of something that is unique, engaging, and/or interactive. Other branding and revenue opportunities are available for the use of exemplary embodiments of the present disclosure, through private and public Wi-Fi networks, such as those available at cafes, airports, hotels, etc. Proprietary branding, content and functionality can be used when exemplary embodiments are utilized by operators of those networks. Additionally, those operators can realize revenues from product and advertising sales associated with their utilization of exemplary embodiments. The same applies to social networks that host these experiences. The features of the platform can be deployed within units in social networking brand pages, social networking sites, articles, mobile devices, etc. There are no boundaries for where the units can be stored or implemented; it can go where the users are.

Exemplary embodiments of the present invention can include an interactive Internet technology platform including multiple highly integrated Graphical User Interfaces or GUI modules, which can be presented to the user as a unified multifunction interface. These modules can be linked to underlying “engines” that can operate in a synchronous manner to provide a seamless engagement for the user. The visual style and physical configuration of these modules can be changed with each campaign to conform to any number of design criteria. The multiple exemplary modules that make up the “user interface” can include a viewer module, a social chat module, a transaction module, and a polling module. Additional “GUI modules” can be added into the technology platform as a “plug and play” module that can be deployed with a click of a button, for example a widget to purchase movie tickets, a widget to pull in a social networking feel, a widget to find directions to a location. The entire campaign interface can be put together by advertisers with a few clicks of a button through a templated back-end by giving the advertiser access to each module, and having the advertiser select which modules to include in the advertisement. The advertiser can then enter in specific information, or add in specific content in designated areas of the module to allow the advertisement to be tailored to the advertiser or the target of the advertisement.

In another exemplary use, the platform could be used for focus group testing, and can require a viewer to go through a set of qualifications in order to join a focus group. Members of the focus group can answer questions, chat, respond to a moderator, and respond to poll results. Separate groups can be setup according to specific demographics after the results have been received. Groups can be setup prior to the start of the focus group (e.g., only users meeting specific demographic qualifications are given access to the focus group). Groups can also be setup after the results have been received (e.g., segments according to demographic information can be filtered after the results have been received). This allows the purveyor of the focus group to easily attain the opinions, of a preferred demographic. For example, if one was looking for information pertaining to men between the ages of 18-34, a focus group can be setup, allowing only users who meet the requisite demographic to gain access to the focus group (e.g., only men ages 18-34). Further, a purveyor of the focus group can allow anyone to participate in the focus group, and the results for men ages 18-34 can be filtered at a later date.

In another exemplary use, the platform can allow for digital video recording (DVR) like functionality in viewing content. If a user wishes to watch live content (e.g., a concert, a movie, a speech or any other live content) that has associated chats, or other time-stamped information, but the user starts the live content late, the user is still able to get the full experience. For example, the user can start the live content from the beginning, which has been recorded, and view all chats, and associated content, as if the user was watching the content live. The user can also go back and forward to any time period, up until a live time period, to view the live content and associated content at that particular time period.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 illustrates a wireframe outline of an exemplary presentation interface, according to one exemplary embodiment of the present disclosure.

FIG. 2 illustrates an example system diagram, according to one example embodiment of the present invention.

FIG. 3 illustrates an example functional flow diagram of one exemplary administrator control, according to one example embodiment of the present disclosure.

FIG. 4 illustrates an example functional flow diagram of one exemplary advertiser control, according to one example embodiment of the present disclosure.

FIG. 5 illustrates an example viewer-user interaction flow, according to one exemplary embodiment of the present disclosure.

FIG. 6 is an illustration of an exemplary block diagram of an exemplary system in accordance with certain exemplary embodiments of the present disclosure;

### DETAILED DESCRIPTION OF THE DISCLOSURE

Exemplary embodiments of the present disclosure can provide a unique advertising experience for online users. Exemplary embodiments can include a viewing window, where the user can view visual content and program material. For example, exemplary embodiments can display a banner advertisement that includes live streaming video of a product presentation. The streaming video can take on any number of forms.

In one exemplary embodiment, the live streaming takes the form used in broadcast media. As an, example, live pitch programs can be incorporated that combine persuasive host personalities along with other marketing features such as an offer that is limited in time and or quantity to create immediacy of demand. This presentation format which has been successfully used in one-way broadcast media can be further exploited using the two-way interactive features possible on the internet. Users can interact with the content and provide feedback to the content producer. The content producer can tailor or modify the live content based on feedback from one or more users. For example, if the content was for a sales pitch of an item, user feedback can direct the price and/or offer of the item, or if the content is a concert, the feedback can direct the next song in a concert.

Content can be targeted to a defined audience based on an array of demographic or other profiles. Further, an interactive environment can be used to further engage the purchaser and assist in the sales process. Further, the use of social media coupled to this form of sales content can drive peers and affinity groups to the sales content and drive sales of a product being promoted.

Streaming video and audio content can originate from any location around the country, or around the world, directly to the appropriate website interface. Even when the content is prerecorded; the content can be synchronized with the other interface functions. This exemplary embodiment can be similar in function to viewing a traditional television broadcast, in that everyone can see the same thing at the same time. Exemplary embodiments can include a lead in broadcast of 15-30 seconds, which can allow the viewer to get caught up on where the broadcast currently is streaming. This lead in broadcast can be an advertisement, a recap segment, or any other presentation.

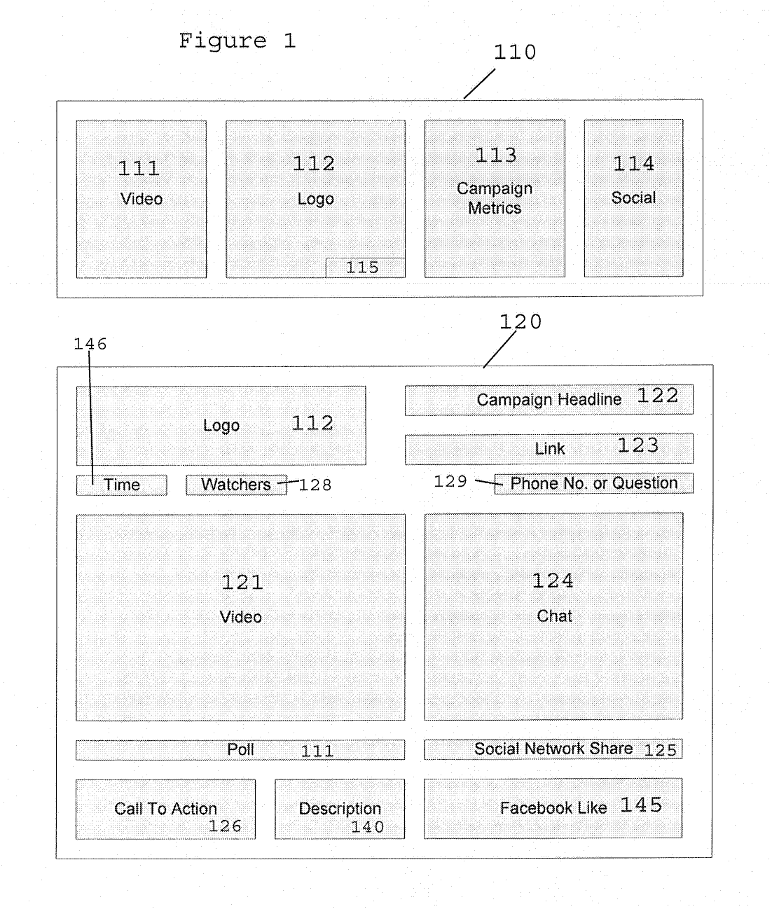

Exemplary embodiments of the present disclosure can include a view-interface for presenting exemplary ad campaigns. FIG. 1 illustrates one example wireframe outline of an exemplary presentation interface. As illustrated, there can be a banner ad area 110, which can be in any location, or any size, and in any orientation. The initial ad area can provide a smaller area of display with an activation function 115 (e.g., a link, a button, a mouse-over area, etc.), which can launch a larger presentation area, banner ad area 120, with additional functionality. The smaller area can include core functions and presentations, such as live streaming video 111, a logo area 112, campaign metrics 113, and/or social sharing links 114. The larger area can include additional functions, such additional text 122, additional links 123, chat functions 124, expanded share links 125, purchase/donate functions 126, poll questions 127, a description 140, third-party feedback functionality 145 (e.g., a Facebook™ like) and/or any other relevant metrics, e.g., 128. Some elements may be identical from banner ad area 110 to banner ad area 120, such as logo 112. Some elements may be similar but expanded, such as video 111 and video 121. Additionally, some elements of banner ad area 110 or banner ad area 120 (collectively “Banner Ad Area”) can be unique to that context, such as contact information 129. The specific functions selection and arrangement of functions, and which content presentations are included in the smaller area can be configured by advertiser-users and/or administrators via the various templates and/or customized configurations/options.

The Banner Ad Area can include editable zones (e.g., description 140) which can change depending on whether the campaign is live or recorded. Banner ad area 120 can have metrics that show how much time is left 146, how many people are watching, and/or whether the banner stream is live or recorded. Video content in the Banner Ad Area can be a preview of the content to be displayed, which can also have an overlay when expanded in banner ad area 120.

The Banner Ad Area can have multiple icon options and module options. Icons can include various functions such as polling options 127 for the viewers and/or a call to action 126, and modules can include alerts, widgets actions (e.g., for ticket purchases), widgets for directions, and/or a chat module 124 although not limited thereto. Any action for each module or icon can be timed, and stored on a server for later review.

The Banner Ad Area can have multiple videos being played at one time, or a playlist like function can be setup to queue multiple videos, such as pre-show content followed by live content.

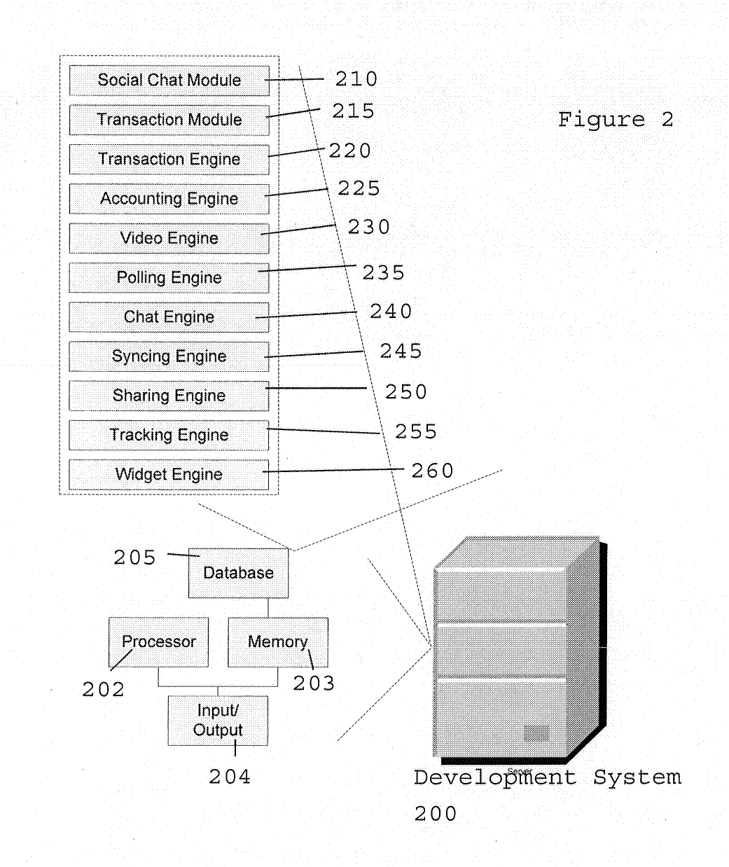

FIG. 2 illustrates an exemplary system of the present disclosure. The exemplary system can include one or more server computer systems, e.g., development system 200. Development system 200 can be one server, a set of local servers, or a set of geographically diverse servers. Additionally, redundant servers can be setup such that if one server is offline, the user can be transferred to a backup or alternate server. Each server can include an electronic computer processor 202, one or more sets of memory 203, including database repositories 205, and various input and output devices 204. These can be local or distributed to several computers and/or locations. Database 205 may include data comprising the various software components of the other example embodiments of the present disclosure, as further discussed below.

Exemplary embodiments of the present disclosure can provide a Social Chat Module 210, e.g., a software module or application which can provide functionality to enable and encourage users to utilize existing and/or new social media accounts to carry on real time exchanges about what they are watching with friends and/or others that are viewing the same campaign that they are. Through the Social Chat Module, users can also invite anyone not currently viewing the campaign to join in this synchronized, collaborative, social viewing experience. For example, a user can log onto a first website to read an article and see a banner advertisement with a real time streaming video of a product for sale. This user can mouse-over the ad to activate a larger view, which can include additional functions, such as social chat and/or social sharing. The ad can be connected to social network APIs, allowing the user to (1) share a link to the ongoing product presentation, (2) post an update about the product and/or the fact the user is viewing, likes, or has purchased the product, and (3) identify other associated users of the social network that are currently online and invite them to a shared viewing experience, where users can chat, etc. This group dynamic promotes the featured product or service to a broader audience and also encourages an affinity group where users in the group will have a purchasing decision encouraged by the purchases of others in the group.

The user can invite his or her friends to watch and the user can filter conversations and chat exchanges to only their friends or a group of friends. Based on interest data from social networks, the module can place users in special groups or if the advertiser is doing a focus group, the advertiser can limit chat exchanges to chosen people or groups and have multiple chat conversations going on. This filter can be performed on the interface.

Exemplary embodiments can offer users options to chat with representatives or with on-camera talent (for live video content) to ask questions and/or comment on what they are seeing, which can enable the broadcaster to address those questions on air. Questions can be received via a telephone operator, an automated telephonic queue in which the question is recorded and transcribed into the administrative back-end for answering, via a form that appears within the platform overlay, and/or any other communication function (e.g., email). Exemplary embodiments can include a polling module, which can give users the ability to take part in surveys and register their opinions on what they are viewing in real-time. Based on the streaming poll results, the broadcaster can adjust broadcast presentation.

Exemplary embodiments of the present disclosure can include a Transaction Module 215 to provide advertisers the ability to transact on the platform by creating a mechanism for users to make secure purchases from within the interface, without leaving the interface or the site they are currently on. The module can be utilized for selling products, soliciting donations to non-profit agencies, campaign contributions to political organizations, and to accept payment for content-on-demand (e.g., Pay-Per-View), as well as, content downloads (e.g., Pay-Per-Download) with any required or desired digital rights management (“DRM”) built-in. Exemplary embodiments can include a dynamic group buying feature (e.g., as part of the transaction engine), which can be employed to offer additional discount opportunities when everyone in a group purchases in concert. For example, the larger the group of shoppers, the greater the discounts. In addition, the initiating user or influencer could become eligible to receive additional discounts and/or free merchandise for subsequent and associated users who purchase products.

One or more exemplary embodiments may implement features through one or more processing engines. For example, exemplary embodiments can implement a Transaction Engine 220, which can be responsible for processing payments within the platform, whether on a mobile device, within an overlay, social networking (e.g., Facebook) application, and/or within a flash expandable ad unit. Users can create an account on the exemplary platform, enter their credit card information, and their information can be stored on exemplary servers so that future purchases anywhere within the network of participating advertisers can be accomplished via an expedited checkout process, all within a secure environment, e.g., within a flash banner. In one exemplary embodiment, the user might see a product he or she wants. The user can then enter their password (e.g., with a username stored in a cookie) and the purchase can be made with their default settings. Appropriate discounts and taxes can be automatically reflected in the total. In exemplary Pay-Per-View applications, the transaction engine can communicate with the video engine to lock the broadcast until payment is made within the system. A video preview can be shown before payment is required to watch the rest of the broadcast. For exemplary Pay-Per-Download applications, the transaction engine can process payments and once the user's credit card is successfully authorized, the user can be prompted to download the requested content, which may be locked by DRM, e.g., in ease the credit card transaction is later denied and/or to secure the file itself from unauthorized transfers/copies.

Video can go back in time with DVR capabilities, and as tied to this DVR functionality, the experience of the platform the user is able to scroll the content back in time. For example, if a user is watching or consuming content or media, the media can be recorded. If a user enters in at minute 10 of the broadcast, the user could decide to go back to minute 5 of the broadcast and see all of the available content that was available at that time including the chat conversations and polls at that period of time. Therefore, the DVR doesn't just apply to video, but can also apply to all elements of the frame.

The exemplary Transaction Engine 220 can report to an Accounting Engine 225 all product and discount offer purchases, pay-per-view, and pay-per-download transactions. The Accounting Engine 225 can be responsible for processing the predetermined distribution of revenue from all product and discount offer purchases, as well as any discounts or free products that users earn from the sharing engine. The Accounting Engine 225 can also handle the post-event billing and reconciliation processes of the exemplary embodiments.

Exemplary embodiments can include a Video Engine 230 that can be responsible for controlling all content that appears in the viewing window from either a live source or streaming recorded video off of a server. The live video can be streamed from any remote source, e.g. with any available Internet connection. In the case of live streaming video, a camera can be switched on and connected (e.g., via Firewire) into a computer input. This stream can be encoded and sent to a content delivery network (“CDN”) that can push it out into the network viewer player. Upon expanding the network viewer, e.g., if the administrator has activated an introduction mode, the user can be shown a brief 30-second recorded introduction video before and/or while being synced to the live stream or live transmission of a recorded video.

In exemplary embodiments providing recorded video, the video can be encoded and sent to a CDN. From there, the exemplary network viewer can receive the video source from the CDN and synchronize the video so that every viewer is watching the video at the same moment or in approximate real time. In exemplary embodiments including a Pay-Per-View application, a preview can be commenced upon launch of the network viewer (e.g., for a set period of time) and then the viewer can be prompted to purchase the stream for continued viewing. The video engine can bring in video from several sources and be mixed on demand, still remaining in sync with the viewers. For example, the video engine could mix between a live stream from camera 1, to a live stream from camera 2, to a PowerPoint file, to a recorded video, and back to a live stream from camera 1.

Exemplary embodiments can include a Polling Engine 235, e.g., a software module or application which can launch polls to viewers on-demand. This can occur immediately after the administrator creates it through the administrator dashboard, which can provide instant feedback. Alternatively or additionally, exemplary polls may be preloaded and/or scheduled for specific delivery (e.g., at a specific time or on a specific triggering event). Once a poll is created, it can appear within the polling section of the network viewer and viewers can then be prompted to respond to the poll. Poll results can then be streamed to the viewer and the admin as the results are received. The broadcaster can receive instant feedback to adjust his or her broadcast, and the viewer can follow along with the results.

Exemplary embodiments can include a Chat Engine 240, e.g., a software module or application including a social chat feature. An exemplary Chat Engine 240 can provide an interactive, live, chat experience amongst everyone watching a broadcast, amongst every socially networked user, and/or any other set/sub-set of users. Users can “check-in” to the chat room by logging in with their account username or password or through an existing social network (e.g., Facebook®, Twitter®, etc.) and once checked in, a status update can be sent to their associated social network announcing they are watching and participating in the broadcast. Then the user can post chat messages into the internal chat. Conversations can be automatically (e.g., programmatically) and/or human moderated and weeded out with spam controls for immediate filtering before being posted. Conversations can be summarized on demand and presented to the administrative live dashboard for the broadcast administrators, so that the broadcaster can adjust his or her broadcast based on the conversations that are happening within the platform, as if it were a virtual focus group.

Exemplary embodiments can include a Syncing Engine 245, e.g., a software application configured to keep the chat engine 240, polling engine 234, and video engine 230 (recorded or live), in sync with one another, so that everyone can be watching the video and participating within the platform in real-time and in the same context, e.g., when a live purchase opportunity presented in the content window has a limited time frame and/or available quantity, the counters representing that data can be accurate and the same for everyone currently viewing, or if a campaign being presented is changed and/or modified based upon real-time reactions and/or feedback from viewers using the chat and/or polling function that change can be seen by everyone. All engines can have the capability of interaction, whereby one action on one engine can affect another. For example, when a user responds to a poll result, based on the majority case, the video engine can change the video to another recorded video in sync with that entry. In another case, based on what a user might say in the chat engine, a discount could be provided to the user in the transaction engine.

Exemplary embodiments can include a Sharing Engine 250, e.g., a software application configured to integrate third part or proprietary social network and email application to provide sharing and tracking functions. Users can share the experience through any of their existing social networking services, including instantaneously posting a message to their social network or to individual friends to join them in the experience. The advertiser can incentivize sharing among users by providing a discount, cash back, or free product to the originator of the share if the originators friend purchases after them. The Sharing Engine can track the sharing process and communicates with the exemplary accounting engine to provide and attribute the discounts, while the tracking engine tracks the number of shares, most influential individuals, conversion rates, and incremental revenues produced through sharing.

Exemplary embodiments can include a Tracking Engine 255, e.g., a software module or application with real-time analytical reporting. For example, a proprietary script can be embedded in the banner and overlay, which can provide conversion data from initial impression to the expanded engagement, while also pulling in live transaction, chat conversations, poll results, and sharing data from the other respective exemplary engines. Data can be viewable in real-time (e.g., through a secure log-in to a virtual command center and administrative back-end for easy analysis by the client and/or company). Data analysis through the command center can be used to make adjustments to a campaign whether live or recorded.

Exemplary embodiments can include a Widget Engine 260 allowing for the custom creation of any additional widgets to be used in the banner ad.

It should be noted that the above description of available modules is not exhaustive, and additional modules or widgets can be added to be run on development system 200.

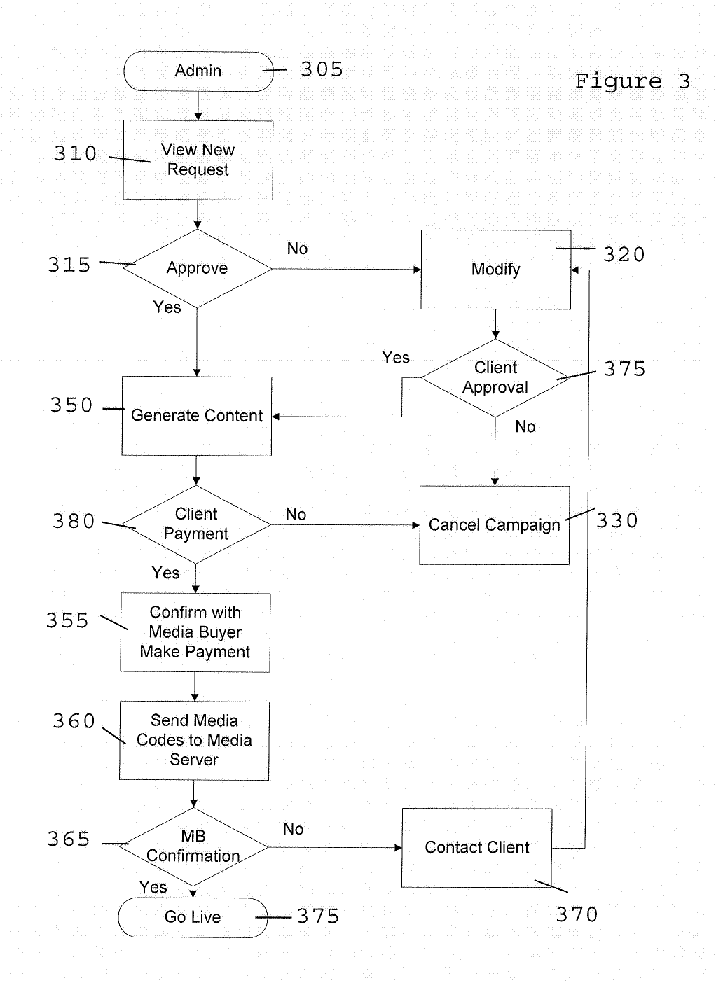

Exemplary embodiments of the present disclosure can include an administrator console for administering one or more advertising campaigns. FIG. 3 is a flow diagram that illustrates one illustrative embodiment of administrator console functions. First, at 310, an administrator 305 can view new requests submitted to the system, and at 315 approve or deny the request. These exemplary requests can be submissions of new campaigns, campaign modifications, new account, canceling a campaign, and/or any number of other requests that may benefit from or require Administrator 305 input. If denied, at 315, an administrator 305 can propose modifications 320 to a particular request or set of requests. The client submitting the request can then approve or reject the modification 375. If rejected, the requested campaign can be canceled at 330. Once the request has been approved, the exemplary embodiment can facilitate content generation 350. Content can be added automatically from set templates whereby the client can add/customize certain required texts or graphs, and/or content can be added manually for a complete customized platform. If a client makes payment at 380, a confirmation 355 can be sent to the media buyer to reserve campaign space (e.g., banner displays). If client payment 380 is not received, then the campaign can be cancelled at 330. Subsequently, at 360, the media codes can be sent to the media buyer, which is confirmed at 365, and can then go live at 375. If the media codes are not confirmed at 365, the client is contacted at 375 to modify to the content at 320.

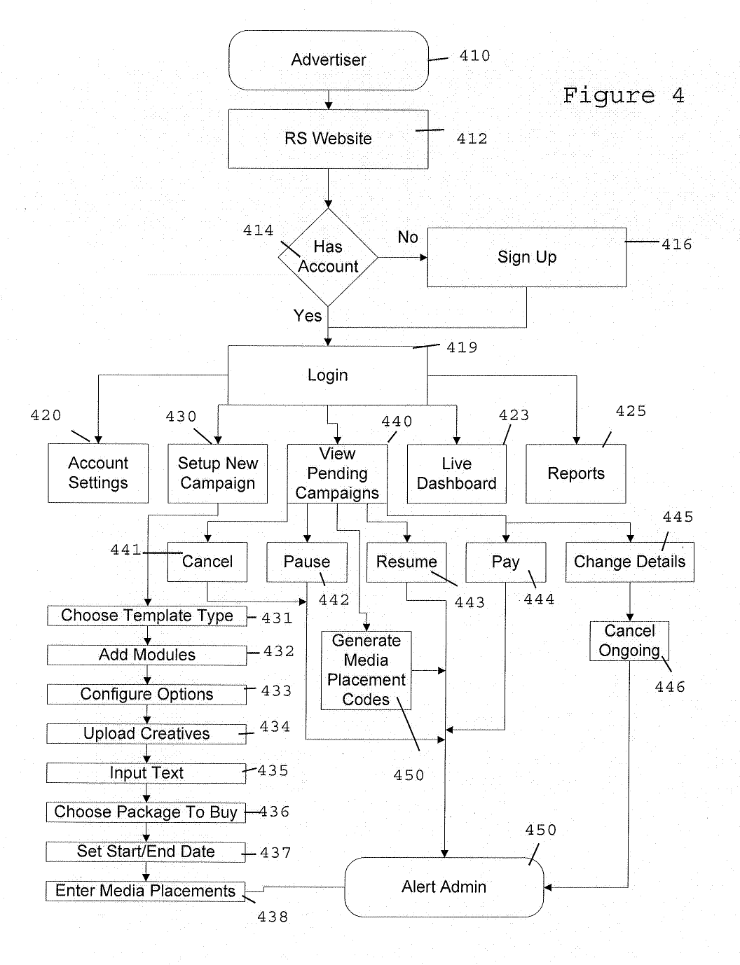

Exemplary embodiments of the present disclosure can further include an advertiser console for administering one or more campaigns. FIG. 4 illustrates one example embodiment of advertiser console functions. At 410 a client advertiser can log into an exemplary advertising consol (e.g., via a web-service) and/or register a new account. Advertisers can adjust their account settings (e.g., at 420), access a live dashboard (e.g., at 423), and/or view reports (e.g., at 425). Advertisers can also setup a new campaign at 430, which can include choosing a template type from various campaign templates at 431. At 432, advertisers can add modules which can include: polls, purchases, volunteering, directions, and any other module from the module store. At 433, advertisers can configure options for the selected modules. Each module can require minor configuring by the advertiser including setting up volunteer fields and links to purchase items, although not limited thereto. At step 434, advertisers can upload creative elements such as videos (or a link to CDN stored videos), art, logos, and/or metadata for integrating a streaming broadcast. At 435, an advertiser can input campaign text, and select banners for the campaign. At 436, advertisers can choose packages to buy from Intercast, including the pricing and volume levels, a turn key solution for an advertiser without needing to contact a sales person to purchase a campaign. At 437, advertisers can set a start and end date for the campaign. Start dates can be immediate, or the campaign can be setup to start at a future date. End dates can be indefinite, and can be entered at a later date. At 438, advertisers can enter media placements of banner ad units that the advertiser has chosen to place the Intercast banner ads on, noting the site and the size of the banners purchased so that tags can be automatically created on the ad serving platform the publisher requires (e.g., Doubleclick or Atlas). An advertiser client can also review their pending campaigns at 440. From here, an advertiser client can cancel campaigns (e.g., at 441), pause campaigns (e.g., at 442), resume campaigns (e.g., at 443), pay for campaigns (e.g., at 444), change details of pending campaigns (e.g., at 445) including cancelling ongoing campaigns (e.g., at 446), and/or generate media placement codes (e.g., at 450). Once a new campaign is created, or an existing campaign is modified or cancelled, an alert is sent to the admin at 455.

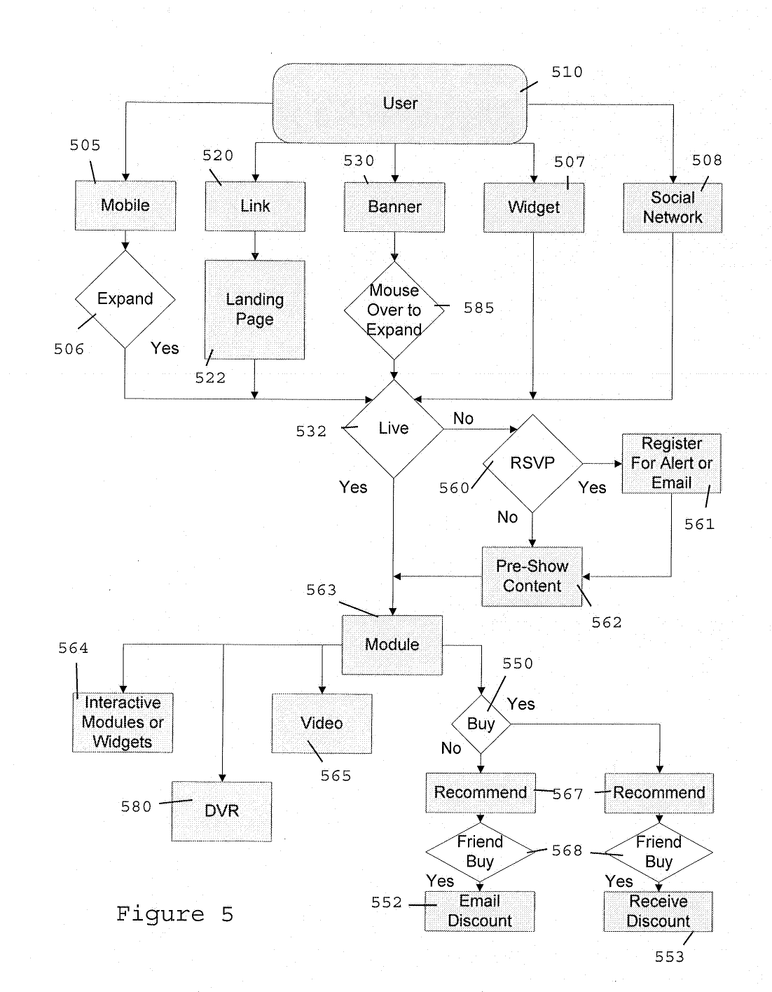

Exemplary embodiments of the present invention can include a user interface for presenting ad campaigns to users in a number of different contexts. FIG. 5 illustrates one exemplary experience for viewer-users of the system who view one or more campaigns. A user 510 can access a participating site and see a link at 520. Responsive to the user 510 clicking on the link at 521, a landing page can be presented at 522. If the page is not live 532 the user 510 is given the option to RSVP at 560. Alternatively, at 530 the user 510 can access a participating site and see a banner. Responsive to the user activating (e.g., by mousing-over the banner 585) the exemplary embodiment can check to see if the campaign is live at 532. Additionally, the user 510 can access the content through a mobile device 505, and can expand the mobile access 506 and check to see if the content is live at 532. Additionally, the user 510 can access live content through a widget 507 or through a social network 508.

If the user 510 elects to RSVP at 560, the user 510 can register to receive an alert or email 561, although not limited thereto. If the user 510 does not RSVP 560, the user can be shown pre-show content 562 prior to the event going live. Once the even goes live, the available modules are activated. Module 563 may include interactive modules or widgets or video 565. Modules can also include the DVR-like functionality 580 as described above

A user 510 can be provided an option to purchase the presented product at 550. The user 510 can also recommend the product to others 567, e.g., via their social network connections. Responsive to a social network connected friend making the recommended purchase 568, the user 510 can be provided a discount and/or discount offer at 552 and 553 respectively.

For various exemplary campaigns, different widgets can be inserted or removed from the dashboard. For example, if an advertiser is selling a product, the dashboard would show the Sales module. The sales module can show stock levels, depletion rates and statistics, and/or estimated time to being out of stock can be provided in the console. Statistics on sales and sales patterns, campaign time remaining, current viewers, current purchasers, click-through rates, and any number of other useful metrics can be presented in the purchase campaign module. If the advertiser is running a fundraising campaign, the dashboard can show the fundraising module, each module having their own metrics. During the campaign setup process, based on the modules the advertiser adds to the campaign, this can auto adjust in the dashboard.

For a fundraising campaign, exemplary aspects can be similar to a purchasing campaign, such as time remaining, total impressions, total “sales” (e.g., donations), etc. Several aspects can be different than a product-based campaign, e.g., a top donors section. Further, exemplary customization features can be different. For example, queued questions can be ordered based on top donor status, ensuring a fund's most generous participants receive the quickest donor-service. Alternatively or additionally, separate or prioritized queues can be provided for donors and potential donors. For an awareness campaign, a purchaser may not be selling a particular product in a particular timeframe, but can use all the other exemplary features (e.g., polling, chat, questions, etc.) with their advertising campaign (e.g., a campaign to promote a brand or product-line).

In the exemplary system, each module can have its own color scheme to differentiate it from the other to be easy for the advertiser eyes to find a module.

The advertiser can look back in time and see how a specific moment in the broadcast how relates to the campaign metrics. By choosing a time, the dashboard will go back into the state of the broadcast at that time with the metrics up until that point. The advertiser can choose Replay to play the entire metrics from the beginning. With each campaign, a prediction can be made by the current data, which can be shown in a graph.

Conversion notes can also be tracked e.g., the number of impressions from an implementation to the number of views of the platform to the number of sales for each distribution point. A mobile device, social network, landing page, and article widget can each have its own conversation area to allow users to communicate with other users viewing the content through the same medium.

Social tracking capabilities can allow for the tracking of sentiment analytics over the time of the broadcast, which is broken into topics and whether that topic being discussed is currently viewed as positive or negative. This can help a politician for example adjust his speech based on how people are receiving the broadcast, or can help in movie trailer testing because a studio could determine at what point in the movie trailer a certain opinion was being generated and whether it was positive or negative without having to read through all of the chat conversations. Polls can be switched out in real time which can be viewed by a user to respond to the new poll, the advertiser can see the results updating in real time in the dashboard. The number of interactions being done can be tracked at a given moment to see how engaging the content is as it's happening

In a live chat, conversations can be moderated. The advertiser can message certain users a specific message from the admin that only they see, creating a two way conversation with the viewer. An advertiser can choose only certain people to talk, as an example a celebrity or special moderator. Words can also be added that will come up as spam and moderate the chat automatically, putting these chats into flagged messages for approval. The advertiser can also secretively block Internet Protocol (IP) addresses, an IP address range or everyone in a certain country.

In a creatives campaign, campaigns can be swapped out in real time. The advertiser can see how one of their interfaces is doing and if it's not performing well, they can swap a banner out for another. A new design can be timed to come up at a certain time or interval. For example, if an advertiser is selling 5 products in a one hour broadcast, the advertiser can time a new creative about that product to launch every 20 minutes and that new design would be deployed across all assets, social network, banner ads, mobile, all the places the platform is. The campaign can be updated everywhere instantly.

Settings allows the advertiser to configure individual modules preferences. For example, setting the shipping price and the text for sharing tools, and settings can be used to configure certain modules such as the movie tickets as referenced above, or by choosing what modules to add to the dashboard, or what the referral amount will be for a user to share a product they bought.

An advertiser can access a social-popup window which can show the advertiser an individual viewer's chat conversation, their age, location, email, number of interactions, ability to remove or ban them, view their purchase history, send them a message, and monitor their sentiment analysis.

A user of the exemplary advertising system can interact with multiple components of the system at once, (e.g., participate in a chat and purchase an item). Users on one platform, such as a mobile device, can interact with people who are on the web experience. This can take the form of a poll in which online viewers are responding to a poll with the results appearing on television or a screen, or if online viewers are talking to each other about a live broadcast on television, without seeing the broadcast online they can watch it on television but still interact in the form of polls and asking questions and chatting. Additionally, the campaign can interact with television to effect some change in the broadcast. Elements of the dashboard could be shown on television, for example, showing sentiment analysis on the television as the live broadcast is being syndicated out to the platform units and feedback generated by the viewers there.

Any suitable technology may be used to implement embodiments of the present disclosure, such as general purpose computers. One or more system servers may operate hardware and/or software modules to facilitate the inventive processes and procedures of the present application, and constitute one or more example embodiments of the present invention. Further, one or more servers may include a computer readable storage medium, with instructions to cause a processor, to execute a set of steps according to one or more example embodiments of the present disclosure.

Further, example embodiments of the present disclosure are directed to one or more processors, which may be implemented using any conventional processing circuit and device or combination thereof, e.g., a Central Processing Unit (CPU) of a Personal Computer (PC) or other workstation processor, to execute code provided, e.g., on a hardware computer-readable medium including any conventional memory device, to perform any of the methods described herein, alone or in combination. The one or more processors may be embodied in a server or user terminal or combination thereof. The user terminal may be embodied as a desktop, laptop, hand-held device, Personal Digital Assistant (PDA), television set-top Internet appliance, mobile telephone, smart phone, etc., or as a combination of one or more thereof. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. Non-transitory storage medium is mean to include all storage mediums except transitory propagation signals. The instructions may be configured to be executed by a processor which, when executing the series of computer instructions, performs or facilitates the performance of all or part of the disclosed methods and procedures.

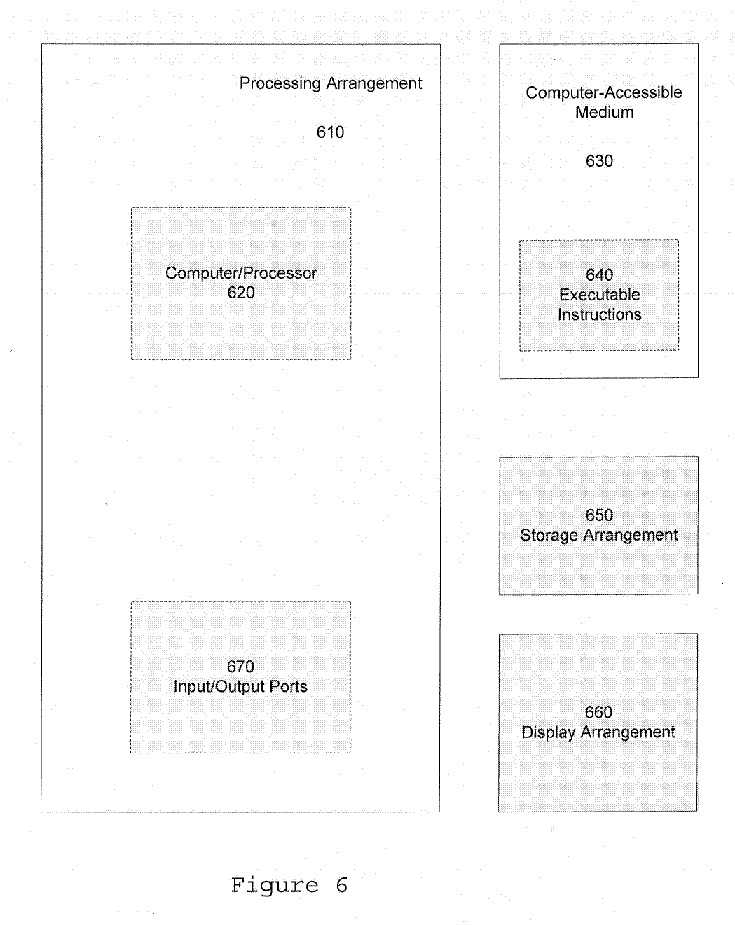

FIG. 6 shows a block diagram of an exemplary embodiment of a system according to the present disclosure. For example, exemplary procedures in accordance with the present disclosure described herein can be performed by a processing arrangement and/or a computing arrangement 602. Such processing/computing arrangement 602 can be, e.g., entirely or a part of, or include, but not limited to, a computer/processor 604 that can include, e.g., one or more microprocessors, and use instructions stored on a computer-accessible medium (e.g., RAM, ROM, hard drive, or other storage device).

As shown in FIG. 6, e.g., a computer-accessible medium 606 (e.g., as described herein above, a storage device such as a hard disk, floppy disk, memory stick, CD-ROM, RAM, ROM, etc., or a collection thereof) can be provided (e.g., in communication with the processing arrangement 602). The computer-accessible medium 106 can contain executable instructions 108 thereon. In addition or alternatively, a storage arrangement 610 can be provided separately from the computer-accessible medium 606, which can provide the instructions to the processing arrangement 602 so as to configure the processing arrangement to execute certain exemplary procedures, processes and methods, as described herein above, for example.

Further, the exemplary processing arrangement 602 can be provided with or include an input/output arrangement 614, which can include, e.g., a wired network, a wireless network, the internet, an intranet, a data collection probe, a sensor, etc. As shown in FIG. 6, the exemplary processing arrangement 602 can be in communication with an exemplary display arrangement 612, which, according to certain exemplary embodiments of the present disclosure, can be a touch-screen configured for inputting information to the processing arrangement in addition to outputting information from the processing arrangement, for example. Further, the exemplary display 612 and/or a storage arrangement 610 can be used to display and/or store data in a user-accessible format and/or user-readable format.

It should be understood that there exist implementations of other variations and modifications of the disclosure and its various aspects, as may be readily apparent to those of ordinary skill in the art, and that the disclosure is not limited by specific embodiments described herein. Features and embodiments described above may be combined. It is therefore contemplated to cover any and all modifications, variations, combinations or equivalents that fall within the scope of the basic underlying principals disclosed and claimed herein.

What is claimed is:

1. A method for consuming content from a given time period comprising:
storing a first media content, the first media content having a first time stamp associated therewith;
storing at least one additional media content, the additional media content having an additional timestamp associated therewith;
associating the additional timestamp of the additional media content with the first time stamp of the first media content;
receiving a content request including a time request;
matching the time request to the first time stamp; and
sending the first media content and the additional media content associated with the first time stamp.

2. The method of claim 1, wherein the content request and the time request is received by a user viewing the first media content and the additional media content.

3. The method of claim 2, wherein the user controls a sliding bar to generate the time request.

4. The method of claim 1, further comprising a play button, a pause button, a fast forward button, and a rewind button to control content playback.

5. The method of claim 1, wherein the first content is a video and the additional content is a chat.

6. The method of claim 1, wherein the first media content and the additional media content is stored on a server.

7. The method of claim 1, wherein the first media content and the additional media content is sent to a user computer to be viewed by a user.

8. A method of creating Internet based advertising from an advertiser comprising:
sending a list of available content modules including a list of configurable areas of the available content modules;
receiving a selection of at least one content module;
sending a configuration request for a configurable area of the selected content module;
receiving customized content for the configurable area; and
sending advertiser content including a video content, the selected content module and the customized content associated with the selected content module.

9. The method of claim 8, wherein the list of available content modules is sent to an advertiser.

10. The method of claim 8, wherein the content, the selected content module, and the customized content associated with the selected content module is sent to a user computer to be viewed by a user.

11. The method of claim 8, wherein the list of available content modules includes a chat content module, a social network content module, a transaction content module, and a polling content module.

12. The method of claim 8, wherein the customized content includes content specific to the advertiser selecting the content modules.

13. The method of claim 8, wherein the advertiser can set a start time and an end time of the video content, the selected content module and the customized content associated with the selected content module.

14. The method of claim 8, wherein a viewer of the advertiser content can interact with the advertiser content.

15. A method for two-way interaction with media content comprising:
sending media content;
receiving feedback based in part on the media content;
modifying the media content based in part on the feedback;
sending the modified media content.

16. The method of claim 15, wherein the media content includes one of at least a video content, a chat content, a polling content or social media content.

17. The method of claim 15, wherein the media content is live content.

18. The method of claim 15, wherein the feedback includes one of at least results of a poll, opinions in a chat, or the number of purchases of a product.

19. The method of claim 15, wherein modifying the media content includes one of at least, changing an order of songs to be played in a concert, changing a topic to be discussed, or changing an advertised special.

20. The method of claim 15, wherein the feedback is received from at least one viewer viewing the content.

21. A system for content advertising over the internet comprising:
a server;
a plurality of configurable content modules stored on the server, the content modules including a video content module, a chat content module, a social network content module, a transaction content module, and a polling content module;
a banner stored on the server configured to display content from the plurality of configurable content modules;
software executing on the server to send the banner to a user computer;
software executing on the user computer to display the banner and associated content modules;
software executing on the user computer to interact with the banner.
